(19) United States
(12) Patent Application Publication
(10) Pub. No.: US 2002/0011730 A1
(43) Pub. Date: Jan. 31, 2002

(54) Apparatus and method for connecting flow conveyances

(76) Inventor: Kelley Allen Stickan, Hugo, MN (US)

Correspondence Address: MERCHANT & GOULD PC, P.O. BOX 2903, MINNEAPOLIS, MN, 55402-0903, US

(21) Appl. No.: 09/864,664

(22) Filed: May 23, 2001

Related U.S. Application Data
(60) Provisional application No. 60/207,605, filed on May 26, 2000.

(51) Int. Cl. F16L 35/00

(52) U.S. Cl. 285/93

(57) ABSTRACT

A coupling for connecting conveyances, so as to allow the flow of commodities from one conveyance to another through the coupling. The coupling includes first and second coupling heads suitable for engagement with each other, and suitable for connection to conveyances. The coupling includes rotary retaining means for retaining the coupling heads in engagement with one another, and latching means for retaining the coupling heads in engagement with one another, whereby the rotary retaining means and the latching means must be simultaneously released to release the coupling heads. When the coupling is engaged, it produces an audible noise. The coupling is adaptable for conveying fluids, electrical power, optical signals, and other commodities. The coupling is adaptable for connection with pipes, hoses, wires, cables, appliances, supply tanks, and other conveyances.

### FIELD

The present invention relates to a coupling for connecting flow conveyances such as tubing, wire, cable, etc. to one another, so as to permit the flow from one conveyance to another through the coupling.

### BACKGROUND

A wide variety of flow conveyances are used to permit the flow of various commodities from one place to another. The range of commodities is very wide, including but not limited to fluids, electrical power, and optical signals. The type of conveyance used generally depends on the nature of the commodity. For example, fluid conveyances may include reservoirs, tanks, hoses, pipes, nozzles, or valves. In contrast, electrical power may be conveyed to or from wires, cables, transformers, generators, appliances, and so forth. Optical signals conveyances include fiber optics, optical switches, signal processing devices, and so forth. Similarly, other conveyances are known for other applications.

Couplings for engaging one conveyance with another are widely used. Known couplings typically comprise a pair of coupling heads, the coupling heads being suitable for engagement with one another, and each coupling head being suitable for connection with an appropriate conveyance. When the coupling heads are engaged, flow through the coupling is enabled.

It is a common problem that coupling heads tend to come uncoupled by accident. This generally results in an interruption of the flow, which often has unfortunate consequences. Loss of fluid flow from a medical device to a patient can be dangerous. Interruption of electrical power flow will shut down and possibly damage equipment that depends on that power. Loss of optical signals can corrupt data communication. Furthermore, uncontrolled flow from an uncoupled conveyance may be a direct danger. For example, the unintended disconnection of a fluid coupling may result in a spill, which, depending on the nature of the fluid, may be a nuisance or a grave hazard. A disconnected electrical coupling may be dangerous if the exposed conductor comes in contact with persons or property.

To avoid these difficulties, flow couplings are commonly fitted with latching mechanisms to prevent accidental uncoupling. Generally, there is a trade-off between ease of use and effectiveness at preventing accidental uncoupling.

For example, it is well known to use one or more threaded nuts to engage coupling heads. Although this is very secure, it requires a significant amount of time and manual dexterity to connect or disconnect such a coupling.

Contrariwise, it is also well known to use a simple friction fit, wherein one coupling head is provided with an opening to accept the other, and the two coupling heads are so sized that friction between their surfaces resists uncoupling. However, although this allows for quick and easy coupling and uncoupling, even a small amount of mechanical stress can uncouple such an apparatus.

Another deficiency of common couplings is the difficulty in determining whether a coupling is securely engaged. Close inspection or experimental stressing of the coupling may be necessary to determine whether it is indeed engaged. This requires time and effort, and under certain circumstances may result in damage to the coupling, the conveyances, or a system to which they are connected. Even with inspection or stressing, the possibility of error is always present.

Still another problem of known couplings is that those which are designed to provide a high level of security have numerous or complex components, and thus are commonly difficult to manufacture.

Yet another deficiency with available couplings is that they tend to have complex internal flow paths. They may have springs, pins, or other objects obstructing the flow path, or they may have sharp turns or tight angles. This is of particular concern with fluid couplings, as in addition to being difficult to manufacture, fluid couplings with complex flow paths tend to accumulate contaminants. Such couplings also are also prone to microorganism growth in isolated portions of the flow path. Furthermore, a complex flow path generally results in greater turbulence, and hence lower flow efficiency through the coupling. Also, certain fluids, including but not limited to wines and pharmaceuticals, are known to be sensitive to physical disruption, and may be damaged if subjected to excessive turbulence.

Still another difficulty with common couplings is that their internal workings are commonly exposed when they are uncoupled. This can lead to contamination, and may also be hazardous depending on the nature of the commodity being carried.

### SUMMARY

The present invention relates to a coupling for connecting flow conveyances such as tubing, wire, cable, etc. to one another, so as to permit the flow from one conveyance to another through the coupling. Although the specifications and drawings herein disclose an embodiment suitable for connecting fluid conveyances, it will be understood by those knowledgeable in the art that this is exemplary only, and that the invention described herein may be equally suitable for use with commodities other than fluids, including but not limited to electrical power and optical signals.

One embodiment of a coupling in accordance with the principles of the present invention includes first and second coupling heads, the coupling heads being suitable for releasable engagement with another, and each coupling head being suitable for connection with a flow conveyance. When the first and second coupling heads are engaged with one another, fluid flow through the coupling is enabled. The coupling includes releasable rotary retaining means, suitable for releasably retaining the first and second coupling heads in engagement with one another. The coupling also includes releasable latching means, suitable for releasably retaining the first and second coupling heads in engagement with one another. The rotary retaining means and the latching means are so constructed that they must both be released at substantially the same time in order to release the first and second coupling heads from engagement.

Because two separate mechanisms must be released to release the coupling heads from engagement, the coupling is resistant to accidental uncoupling. However, because both mechanisms function in a straightforward manner, the coupling is easily coupled and uncoupled.

In another embodiment of a coupling in accordance with the principles of the present invention, the coupling produces an audible noise upon engagement of the coupling heads.

In another embodiment of a coupling in accordance with the principles of the present invention, the coupling heads include shrouds that restrict contact with their insides.

In still another embodiment of a coupling in accordance with-the principles of the present invention, the coupling heads are each one-piece, integrally formed structures.

In yet another embodiment of a coupling in accordance with the principles of the present invention, the first and second coupling heads have first and second passages respectively therethrough, such that when the coupling heads are engaged the first and second passages cooperate to form a flow passage through the coupling. Thereby, fluid flow through the coupling is enabled. The flow passage is generally smooth and without obstruction, so as to minimize the deposition of contaminants, the growth of microorganisms, and the creation of turbulence in fluid flowing through the coupling.

A variety of additional advantages of the invention will be set forth in part in the description that follows, and in part will be obvious from the description, or may be learned by practice of the invention. The advantages of the invention will be realized and attained by means of the elements and combinations particularly pointed out in the claims. It is to be understood that both the foregoing general description and the following detailed description are exemplary and explanatory only and are not restrictive of the invention as claimed.

### BRIEF DESCRIPTION OF THE DRAWINGS

Like reference numbers generally indicate corresponding elements in the figures.

FIG. 1 is a perspective view of a preferred embodiment of a coupling in accordance with the principles of the present invention.

FIG. 2 is a perspective view of a first coupling head of the coupling shown in FIG. 1.

FIG. 3 is a perspective view of a second coupling head of the coupling shown in FIG. 1.

FIG. 4 is a longitudinal cross-section of another preferred embodiment of a coupling in accordance with the principles of the present invention.

FIG. 5 is a perspective view of a cap suitable for a first coupling head of the coupling shown in FIG. 1.

FIG. 6 is a perspective view of a cap suitable for a second coupling head of the coupling shown in FIG. 1.

FIG. 7 is a longitudinal external view a preferred embodiment of a conveying system in accordance with the principles of the present invention.

### DETAILED DESCRIPTION

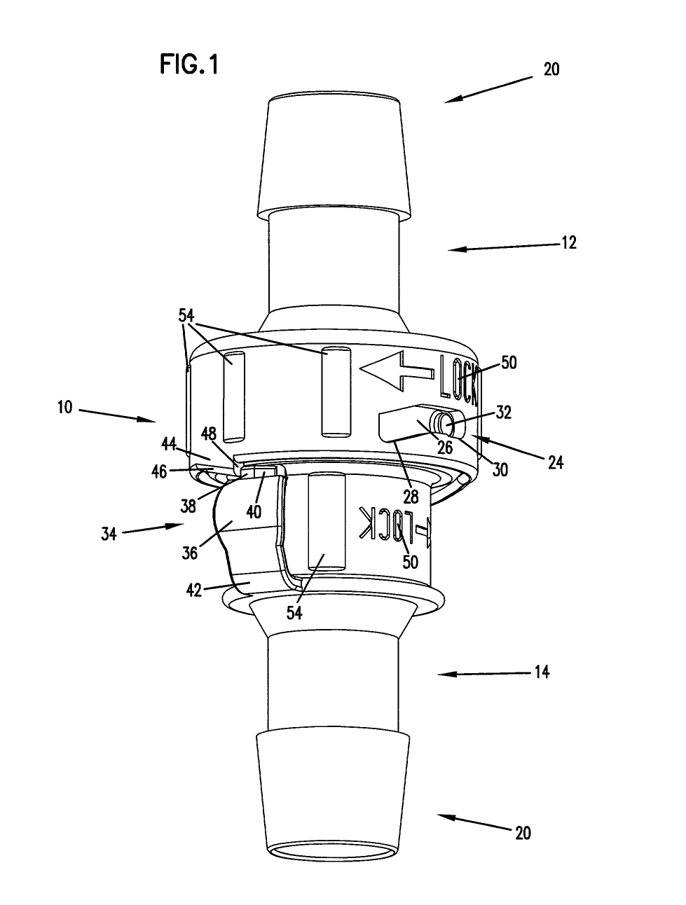

FIGS. 1-3 illustrate a preferred embodiment of a coupling in accordance with the principles of the present invention, the coupling being generally referenced by the reference number 10. The coupling 10 comprises a first coupling head 12, and a second coupling head 14. Each of the first and second coupling heads 12 and 14 comprise a coupling end 18 and a conveyance end 20. The first and second coupling heads 12 and 14 are suitable for releasable engagement with one another at their coupling ends 18. When the first and second coupling heads 12 and 14 are in engagement with one another, flow through the coupling 10 is enabled.

The coupling 10 comprises a releasable rotary retaining means 24. The coupling likewise comprises releasable latching means 34. The rotary retaining means 24 and the releasable latching means 34 cooperate in such a fashion that both must be released at substantially the same time in order to release the first and second coupling heads 12 and 14 from engagement with one another.

As is visible in FIG. 7, each of the first and second coupling heads 12 and 14 are suitable for connection with a flow conveyance 16. As shown, the conveyances 16 are hoses, and the conveyance ends 20 of the first and second coupling heads 12 and 14 are barbed so as to be suitable for connection with hoses. Such an embodiment is advantageous, as it is suitable for carrying a wide variety of fluids, including but not limited to beverages, foods, inks, medicines, detergents, solvents, etc. However, it will be apparent to those knowledgeable in the art that this configuration is exemplary only, and that other conveyances and conveyance ends may be equally suitable. In particular, it is envisioned that an embodiment of a coupling in accordance with the principles of the present invention may be suitable for connection with other fluid conveyances, including but not limited to pipes, bags, bottles, drums, Gaylords, valves, dispensers, etc. It is further envisioned that an embodiment of a coupling in accordance with the principles of the present invention may be suitable for conveying commodities other than fluids, including but not limited to electrical power and optical signals. Other suitable applications may be apparent to those knowledgeable in the art.

It is preferable that the rotary retaining means 24 comprises an arrangement of slots 26 and pins 32. As illustrated in FIGS. 1-3, the first coupling head 12 comprises two slots 26, the slots 26 being formed so that a start end 28 of each slot 26 is closer to the coupling end 18 of the first coupling head 12 than a stop end 30 of each slot 26. The second coupling head 14 comprises two pins 32, the pins 32 being sized so as to fit into the start end 28 of each slot 26, but not past the stop end 30 of each slot 26. It is envisioned that the rotary engagement means 24 as shown would be engaged by inserting the coupling end 18 of the second coupling head 14 into the coupling end 18 of the first coupling head 12 oriented so that the pins 32 align with the start ends 28 of the slots 26, then rotating the second coupling head 14 relative to the first coupling head 12 in a first direction until the pins 28 reach the stop ends 30 of the slots. Because the pins 32 are sized not to fit past the stop ends 30 of the slots 26, the second coupling head 14 cannot be rotated in the first direction beyond this point. This configuration is commonly referred to by those knowledgeable in the art as a “bayonet joint”. It is advantageous, in that it is relatively secure, and easily manufactured and operated, and provides a solid stop after installation. That is, it cannot be overtightened, as can for example some threaded joints. However, it will be apparent to those knowledgeable in the art that such a configuration is exemplary only, and that other configurations may be equally suitable. In particular, depending on the application, it may be suitable to have only a single pin or a single slot, or a plurality of pins or slots. Likewise, it may be suitable to locate the slot or slots on the second coupling head, and the pin or pins on the first coupling head. Furthermore, it may be suitable to use a different rotary retaining means entirely.

It is also preferable that the latching means 34 comprises an arrangement of clip members 36 and tab members 42. As illustrated in FIGS. 1-3, the first coupling head comprises two tab members 44. It is envisioned that the tab members will be generally wedge-shaped with a sliding edge 46 and an abutting edge 48. The second coupling head 14 comprises a clip member 36 with a latch head 38 thereon. It is envisioned that the clip member 36 is actuatable between a release position, whereby engaging and disengaging the rotary retaining means 24 is enabled, and a retaining position, whereby engaging and disengaging the rotary retaining means 24 is not enabled. As is best visible in FIG. 1, it is further envisioned that, in the retaining position, the clip member 36 is so positioned that the latch head 38 cooperates with the abutting edge 48 of a tab member 44 to prevent the rotation of the second coupling head 14 relative to the first coupling head 12 in a second direction generally opposite the first direction. It is likewise envisioned that in the release position the clip member 36 will be so positioned that the latch head 38 does not cooperate with the abutting edge 48 of a tab member 44. However, it will be apparent to those knowledgeable in the art that such a configuration is exemplary only, and that other configurations may be equally suitable. In particular, it may be suitable to provide only a single tab member, or to provide two clip members. Likewise, it may be suitable to provide a plurality of tab members and clip members. Furthermore, it may be suitable to use a different latching means entirely.

It is preferable that the clip member 36 will be actuated to the release configuration by the application of pressure to the clip member 36. However, it will be apparent to those knowledgeable in the art that such an arrangement is exemplary only, and that other arrangements may be equally suitable.

It is also preferable that the latching means 34 will comprise biasing means 42 for biasing the clip member 36 towards the retaining position. It is further envisioned that the biasing means 42 will comprise a flexure spring integrally molded with the clip member 36. However, it will be apparent to those knowledgeable in the art that such a configuration is exemplary only, and that other configurations may be equally suitable.

It is additionally preferable that that the latching means 34 will comprise urging means 40 for urging the clip member 36 towards the release position when the rotary retaining means 24 are being engaged. Furthermore, it is envisioned that the urging means 40 will comprise a wedge-shaped surface of the latch head 38, suitable for cooperating with the sliding edge 46 of a tab member 44, to urge the clip member 36 towards the release position when the rotary retaining means 24 are being engaged. However, it will be apparent to those knowledgeable in the art that such a configuration is exemplary only, and that other configurations may be equally suitable.

As illustrated in FIGS. 1-3, the rotary retaining means 24 and the latching means 34 must be substantially simultaneously released in order to release the first and second coupling heads 12 and 14 from engagement with one another. As shown, the rotary retaining means 24 cannot be released alone because the latching means 34 prevent rotation of the second coupling head 14 relative to the first coupling head 12 in the second direction. Conversely, even if the latching means 34 are released, the rotary retaining means 24 continue to engage the first and second coupling heads 12 and 14. Thus, only with the essentially simultaneous release of the latching means 34 and the rotary retaining means 24 can the first and second heads 12 and 14 be released from engagement. This is advantageous, in that although both the rotary retaining means 24 and the latching means 34 are easily manipulated and manufactured, the combination of the two produces in a coupling that requires simultaneous compression and rotation stresses in order to be disengaged, and thus results in a coupling that is highly resistant to accidental disengagement. However, it will be apparent to those knowledgeable in the art that these rotary retaining means and latching means are exemplary only, and that other such means may be equally suitable.

In another embodiment of a coupling 10 in accordance with the principles of the present invention, the coupling 10 produces an audible noise upon engagement of the first and second coupling heads 12 and 14 with one another. This is advantageous, in that it allows confirmation of full and correct engagement of the first and second coupling heads 12 and 14 without a close visual inspection of the coupling 10. It is envisioned that as the rotary retaining means 24 are fully engaged, when the latch head 38 will passes the abutting edge 48 of a tab member 44, the biasing means 42 will cause the clip member 36 to rapidly actuate towards the retaining position, whereby the latch head 38 and the abutting edge 48 cooperate to frictionally generate a sharp snapping or popping sound. However, it will be apparent to those knowledgeable in the art that such an arrangement is exemplary only, and that other arrangements may be equally suitable. It will also be apparent that it may be appropriate for some applications to avoid producing any audible noise upon engagement.

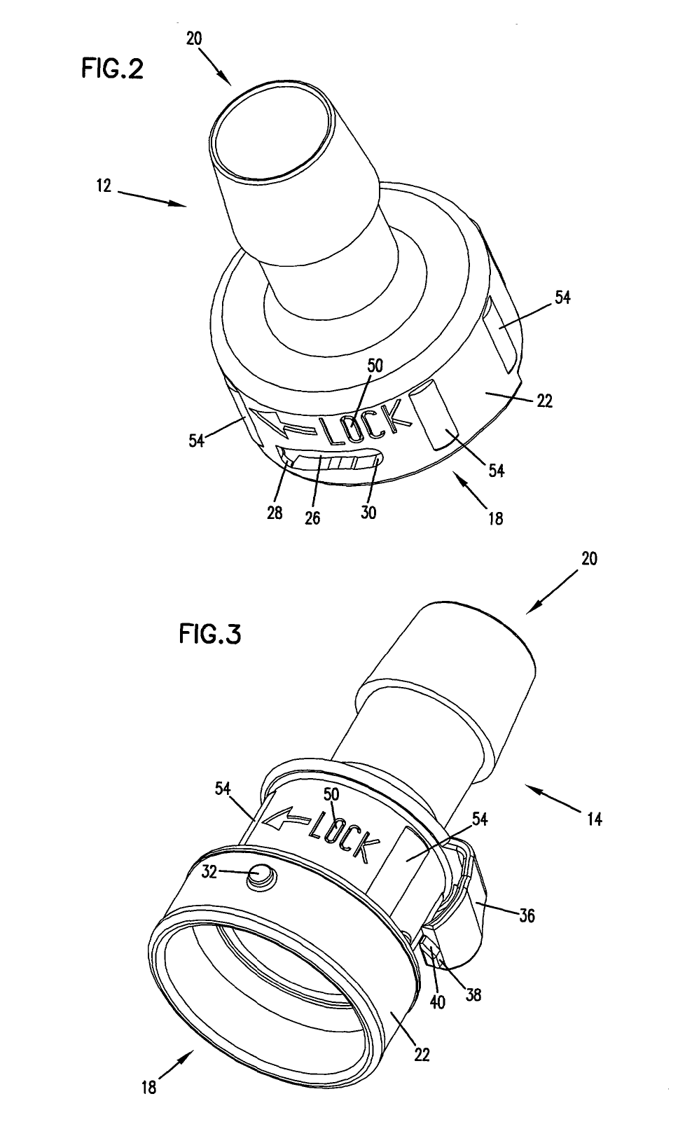

In another embodiment of a coupling 10 in accordance with the principles of the present invention, best seen in FIGS. 2 and 3 , the first and second coupling heads 12 and 14 comprise shrouds 22 to restrict contact with their insides. Depending on their application, the first and second coupling heads 12 and 14 may have internal components such as electrical wires, fluid passages, etc., and contact with them may be undesirable or even dangerous. Likewise, contact with traces of the commodities conducted through the coupling may be undesireable or dangerous. It is envisioned that the shrouds will comprise generally cylindrical walls concentric with a central axis of the first and second coupling heads 12 and 14. This is advantageous, in that it restricts contact with any internal components of the first and second coupling heads 12 and 14 from all directions except approximately straight forward of their coupling ends 18. It is further advantageous, in that it allows the first and second coupling heads 12 and 14 to be set on a horizontal surface without permitting contact to any internal components. However, it will be apparent to those knowledgeable in the art that such a configuration is exemplary only, and that other configurations may be equally suitable. In particular, it may be advantageous for some applications to incorporate a shroud in only one of the first and second coupling heads. Likewise, it may be advantageous to omit the shroud entirely.

In still another embodiment of a coupling 10 in accordance with the principles of the present invention, the latching means 34 is frangible, whereby releasing the latching means 34 causes it to break so that it may not be reused. This is advantageous for applications in which sterility or cleanliness is of great importance, including but not limited to food processing and medical procedures. It is envisioned that the clip member 36 would be made of a rigid material, and that some portion thereof would be scored, made deliberately thin, or otherwise weakened, so that the clip member 36 would have to be broken completely off in order to release the latching means 34 and thereby release the first and second coupling heads 12 and 14 from engagement. However, it will be apparent to those knowledgeable in the art that such an arrangement is exemplary only, and that other arrangements may be equally suitable.

In yet another embodiment of a coupling 10 in accordance with the principles of the present invention, at least one of the first and second coupling heads 12 and 14 comprises indicia 50 disclosing at least instructions for engaging the first and second coupling heads 12 and 14. It is envisioned that the indicia 50 comprise an arrow indicating the relative direction in which the first and second coupling heads 12 and 14 must be rotated for engagement, and the word “lock”. However, it will be apparent to those knowledgeable in the art that such an arrangement is exemplary only, and that other arrangements may be equally suitable. In particular, it may be advantageous for some applications to disclose instructions for disengaging the coupling. Likewise, it may be advantageous to use other words or symbols, in particular non-English indicia. Furthermore, it may be advantageous for certain applications to omit the indicia entirely.

In another embodiment of a coupling 10 in accordance with the principles of the present invention, at least one of the first and second coupling heads 12 and 14 comprises at least one grip member 54, the grip members providing improved purchase on the first and second coupling heads 12 and 14 so that they may be more easily rotated relative to one another, and hence more easily engaged and disengaged. It is envision that the grip members 54 comprise raised ridges. However, it will be apparent to those knowledgeable in the art that this configuration is exemplary only, and that other configurations may be equally suitable. In particular, it may be advantageous to for some applications to incorporate textured or roughened surfaces, raised bumps, grooved depressions, etc. Likewise, it may be advantageous for some applications to omit the grip members.

In still another embodiment of a coupling 10 in accordance with the principles of the present invention, at least one of the first and second coupling heads 12 and 14 is a one-piece, integrally formed structure. This is advantageous, in that it permits efficient and inexpensive manufacture and assembly. Such a configuration also tends to be highly reliable, as there are relatively few components to fail. However, it will be apparent to those knowledgeable in the art that such a configuration is exemplary only, and that other configurations may be equally suitable. In particular, it may be advantageous in certain applications for the coupling heads to be made with multiple pieces.

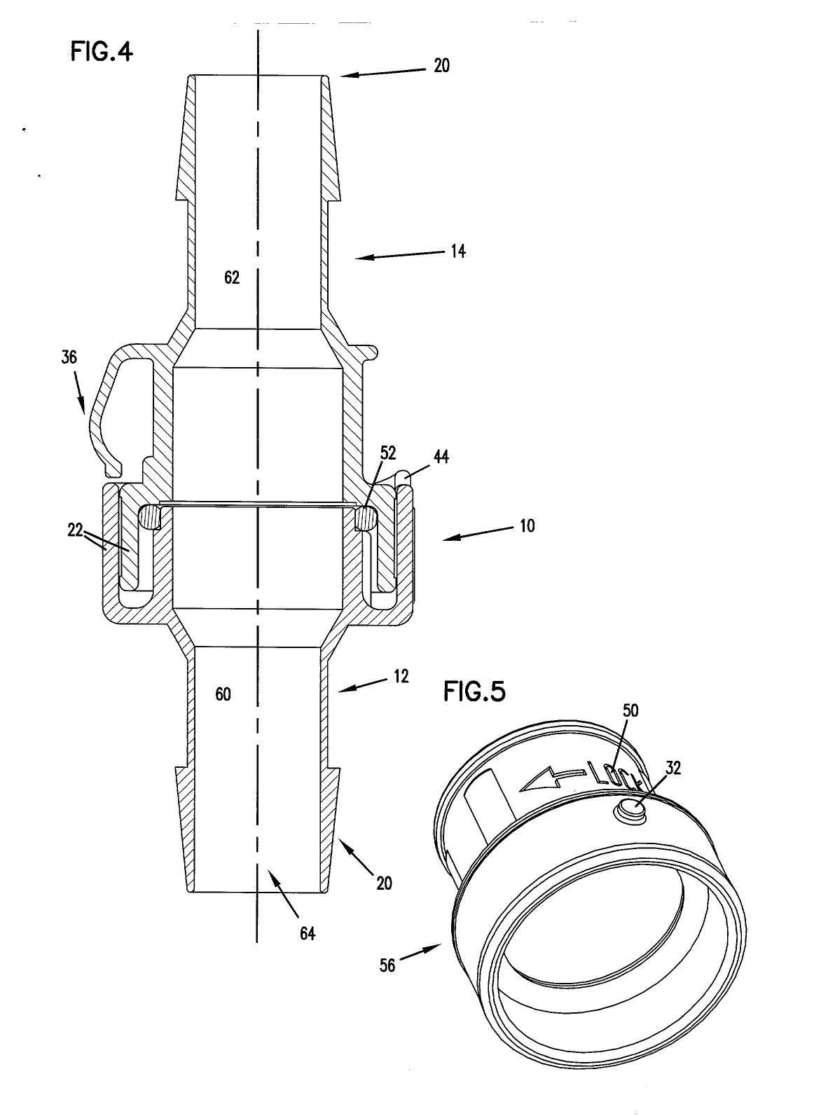

As is best visible in FIG. 4, in yet another embodiment of a coupling 10 in accordance with the principles of the present invention, the first coupling head 12 comprises a first passage 60 therethrough, and the second coupling head 14 comprises a second passage 62 therethrough, whereby when the first and second coupling heads 12 and 14 are in engagement with one another, the first and second passages 60 and 62 cooperate to form a flow passage 64 through the coupling 10, whereby fluid flow through the coupling 10 is enabled. Such a configuration is advantageous for fluid flow. However, it will be apparent to those knowledgeable in the art that this configuration is exemplary only, and that other configurations may be advantageous for other applications, including but not limited to electrical power flow and optical signal flow.

It is envisioned that the flow passage 64 is generally smooth and without obstruction. This is advantageous, in that such a smooth structure limits the availability of sites hospitable for the growth of micro-organisms or the accumulation of contaminants. Furthermore, a smooth structure provides for reduced turbulence in fluid flowing therethrough, thereby improving flow efficiency through the coupling 10, and reducing the risk of damage to turbulence-sensitive fluids flowing therethrough. However, it will be apparent to those knowledgeable in the art that this configuration is exemplary only, and that other configurations may be advantageous for other applications.

In another embodiment of a coupling 10 in accordance with the principles of the present invention, the coupling 10 comprises at least one sealing member, whereby the sealing member provides a fluid tight seal between the first and second coupling heads 12 and 14 when they are in engagement with one another. This is advantageous for fluid couplings, in that the sealing member 52 acts to prevent leaks of the fluid being conveyed from the coupling into the outside environment. This is also advantageous for other couplings, in that the sealing member 52 acts to prevent the entry of environmental hazards from entering the coupling. For example, this includes but is not limited to the entry of water into electrical couplings. It is envisioned that the sealing member 52 is an O-ring. However, it will be apparent to those knowledgeable in the art that this configuration is exemplary only, and that other configurations may be equally suitable. In particular, for certain applications it may be advantageous to omit a sealing member.

It is envisioned that the coupling 10 is composed of a plastic material. This is advantageous, in that plastic materials are typically inexpensive, light-weight, easily formed, generally inert, and easily cleaned and sterilized. Many plastics are known to have suitable properties for a coupling 10 in accordance with the principles of the present invention. It is further envisioned that the coupling 10 is composed of polysulfone or polycarbonate, as these materials are known to have suitable properties. However, it will be apparent to those knowledgeable in the art that this is exemplary only, and that other materials may be equally suitable. In particular, other suitable materials may include but are not limited to rubber, metal, glass, ceramic, or wood.

As is visible in FIG. 5, in still another embodiment of a coupling in accordance with the principles of the present invention, the first coupling head 12 is suitable for engaging with a first protective cover 56 when the first coupling head 12 is not in engagement with the second coupling head 14. It is envisioned that the first protective cover 56 will comprise pins 32 suitable for engaging with slots 26 in the first coupling head 12 to form rotary retaining means 24. However, it will be apparent to those knowledgeable in the art that this configuration is exemplary only, and that other configurations may be equally suitable.

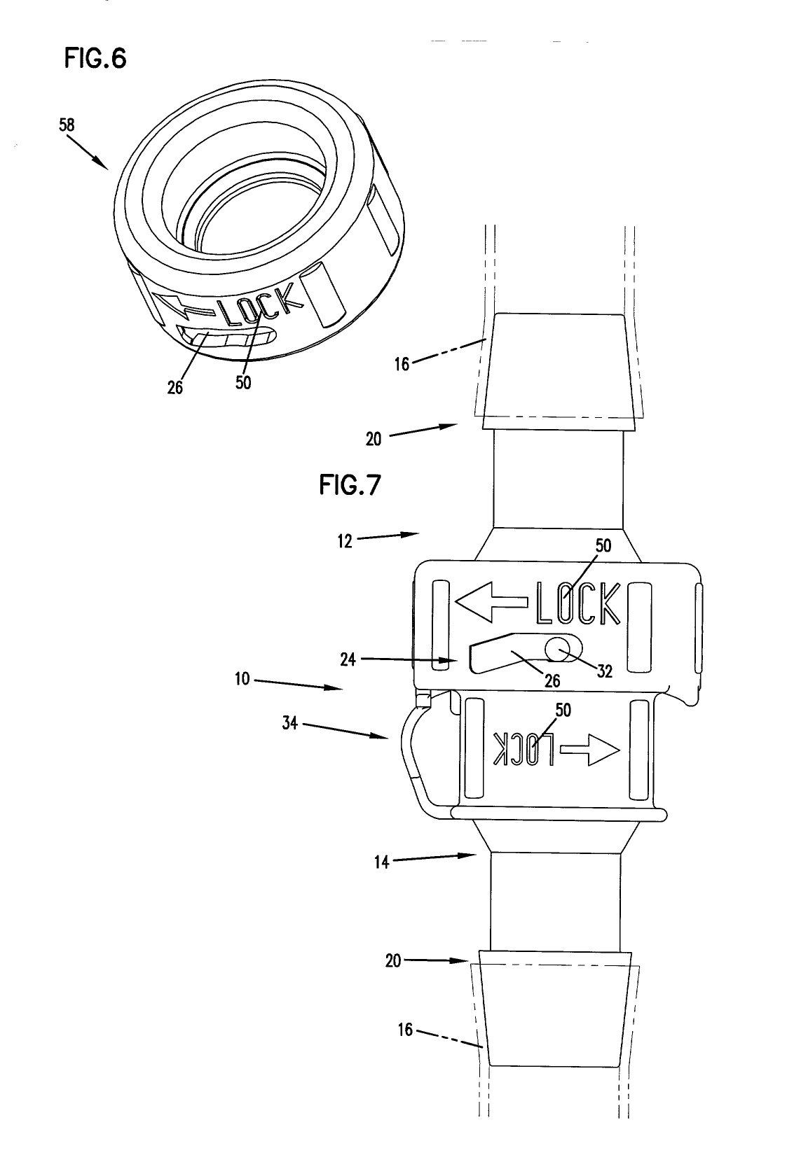

As is visible in FIG. 6, in yet another embodiment of a coupling in accordance with the principles of the present invention, the second coupling head 14 is suitable for engaging with a second protective cover 58 when the first coupling head 14 is not in engagement with the first coupling head 12. It is envisioned that the second protective cover 58 will comprise slots 26 suitable for engaging with pins 32 in the second coupling head 14 to form rotary retaining means 24. However, it will be apparent to those knowledgeable in the art that this configuration is exemplary only, and that other configurations may be equally suitable.

It is to be understood that while certain embodiments of the present invention have been illustrated and described, the invention is not limited to the specific forms or arrangements of the parts described and shown, and that the specification and depicted embodiment is to be considered exemplary only, with the true scope and spirit of the invention being indicated by the broad meaning of the following claims.

I claim:

1. A coupling for connecting flow conveyances, comprising:
first and second coupling heads, said first and second coupling heads being suitable for releasable engagement with one another, and said first and second coupling heads each being suitable for connection with a flow conveyance;
releasable rotary retaining means, said rotary retaining means being suitable for releasably retaining said first and second coupling heads in engagement with one another; and
releasable latching means, said latching means being suitable for releasably retaining said first and second coupling heads in engagement with one another;
whereby when said first and second coupling heads are in engagement, flow through said coupling is enabled; and
whereby said rotary retaining means and said latching means cooperate such that they must be substantially simultaneously released to release said first and second coupling heads from engagement with one another.

2. The coupling of claim 1, wherein said latching means comprises:
at least one tab member on one of said first and second coupling heads; and
at least one clip member on the other of said first and second coupling heads;
wherein said at least one clip member is actuatable between a release position, whereby release and engagement of said rotary retaining means is enabled, and a retaining position, whereby release and engagement of said rotary retaining means is not enabled.

3. The coupling of claim 2, further comprising:
biasing means for biasing said clip member towards said retaining position.

4. The coupling of claim 3, further comprising:
urging means for urging said clip member towards said release position when said rotary retaining means are being engaged.

5. The coupling of claim 1, farther comprising:
means for producing an audible noise upon engagement of said first and second coupling heads.

6. The coupling of claim 1, wherein:
said first coupling head comprises a first passage therethrough, and said second coupling head comprises a second passage therethrough, whereby when said first and second coupling heads are in engagement with one another said first and second passages cooperate to form a flow passage through said coupling, whereby fluid flow through said coupling is enabled.

7. The coupling of claim 6, wherein:
said flow passage is generally smooth and without obstruction.

8. The coupling of claim 6, further comprising:
at least one sealing member, whereby said sealing member provides a fluid-tight seal between said first and second coupling heads when said first and second coupling heads are in engagement with one another.

9. The coupling of claim 8, wherein:
said at least one sealing member is an O-ring.

10. The coupling of claim 1, wherein:
at least one of said first and second coupling heads is a one-piece, integrally formed structure.

11. The coupling of claim 1, wherein:
said first coupling head is suitable for engaging with a first protective cover, when said first coupling head is not in engagement with said second coupling head.

12. The coupling of claim 1, wherein:
said second coupling head is suitable for engaging with a second protective cover, when said second coupling head is not in engagement with said first coupling head.

13. The coupling of claim 1, wherein
at least one of said first and second coupling heads comprises a shroud around said coupling head.

14. The coupling of claim 1, wherein:
said latching means are frangible, whereby releasing said latching means causes said latching means to break.

15. The coupling of claim 1, wherein:
said coupling is made of plastic.

16. The coupling of claim 15, wherein:
said coupling is made of one of the group composed of polysulfone and polycarbonate.

17. The coupling of claim 1, wherein:
at least one of said first and second coupling heads comprises indicia disclosing at least instructions for engaging said coupling.

18. The coupling of claim 1, wherein:
at least one of said first and second coupling heads comprises at least one gripping member that enables ease of rotation.

19. A coupling for connecting fluid conveyances, comprising:
a first coupling head, wherein:
said first coupling head is a one-piece integrally formed structure;
said first coupling head comprises a first passage therethrough;
said first coupling head is suitable for connection with a flow conveyance;
said first coupling head comprises a shroud around said first coupling head;
said first coupling head is made of one of the group composed of polysulfone and polycarbonate;
said first coupling head comprises indicia disclosing instructions for engaging said first and second coupling heads; and
said first coupling head comprises gripping structures to enable ease of rotation;
a second coupling head, wherein;
said second coupling head is a one-piece integrally formed structure;
said second coupling head comprises a second passage therethrough;
said second coupling head is suitable for connection with a flow conveyance;
said second coupling head comprises a shroud around said second coupling head;
said second coupling head is made of one of the group composed of polysulfone and polycarbonate;
said second coupling head comprises indicia disclosing instructions for engaging said first and second coupling heads; and
said second coupling head comprises gripping structures to enable ease of rotation;
wherein said first and second coupling heads are suitable for releasable engagement with one another, whereby when said first and second coupling heads are in engagement with one another said first and second passages cooperate to form a flow passage through said coupling, whereby fluid flow through said coupling is enabled, said flow passage being generally smooth and without obstruction; and
wherein when said first and second coupling heads are suitable for engaging with protective covers when said first and second coupling heads are not in engagement with one another;
at least one sealing member, whereby said sealing member provides a fluid tight seal between said first and second coupling heads when said first and second coupling heads are in engagement with one another;
releasable rotary retaining means, said rotary retaining means being suitable for releasably retaining said first and second coupling heads in engagement with one another;
releasable latching means, said latching means comprising:
at least one tab member on one of said first and second coupling heads; and
at least one clip member on the other of said first and-second coupling heads;
wherein said at least one clip member is actuatable between a release position, whereby release and engagement of said rotary retaining means is enabled, and a retaining position, whereby release or engagement of said rotary retaining means is not enabled;
biasing means for biasing said clip member towards said retaining position;
urging means for urging said clip member towards a release position when said rotary retaining means are being engaged; and
means for producing an audible noise upon engagement of said first and second coupling heads;
whereby when said first and second coupling heads are in engagement, flow through said coupling is enabled; and
whereby said rotary retaining means and said latching means cooperate such that they must be substantially simultaneously released to release said first and second coupling heads from engagement with one another.

20. A method for connecting flow conveyances using a coupling, said coupling comprising
first and second coupling heads, said first and second coupling heads being suitable for releasable engagement with one another, said first and second coupling heads each being suitable for connection with a flow line;
rotary retaining means on at least one of said first and second coupling heads, wherein said rotary engaging means are suitable for releasably retaining said first and second coupling heads in engagement with one another;
latching means on at least one of said first and second coupling heads, wherein said latching means are suitable for releasably retaining said first and second coupling heads in engagement with one another;
whereby said rotary retaining means and said latching means cooperate such that they must be substantially simultaneously released to release said first and second coupling heads from engagement with one another;
the method comprising:
engaging said first and second coupling heads with one another;
rotating said first and second coupling heads relative to one another to engage said rotary retaining means;
engaging said latching means.

21. A conveying system, comprising:
a first conveyance
a second conveyance
a coupling connecting said first and second conveyances, whereby flow from said first conveyance through said coupling to said second conveyance is enabled, said coupling comprising:
a first coupling head connected to said first conveyance, and a second coupling head connected to said second conveyance, said first and second coupling heads being suitable for releasable engagement with one another;
releasable rotary retaining means, said rotary retaining means being suitable for releasably retaining said first and second coupling heads in engagement with one another; and
releasable latching means, said latching means being suitable for releasably retaining said first and second coupling heads in engagement with one another;
whereby said rotary retaining means and said latching means must be substantially simultaneously released to release said first and second coupling heads from engagement with one another.
